(19) United States
(12) Patent Application Publication
(10) Pub. No.: US 2025/0363747 A1
(43) Pub. Date: Nov. 27, 2025

(54) SYSTEMS AND METHODS FOR VIRTUAL ASSISTANTS IN VIRTUAL REALITY MEETINGS

(71) Applicant: Meta Platforms, Inc., Menlo Park, CA (US)

(72) Inventors: Ankush Bagotra, Milpitas, CA (US); Saeed Jahed, Seattle, WA (US)

(21) Appl. No.: 18/674,193

(22) Filed: May 24, 2024

(51) Int. Cl. G06T 19/00; G06F 40/169; G06T 17/00

(52) U.S. Cl. CPC G06T 19/00; G06T 17/00; G06F 40/169; G06T 2200/24; G06T 2219/024

(57) ABSTRACT

A computer-implemented method for virtual assistants performing actions during virtual reality meetings may include (i) identifying a meeting in a virtual reality environment that includes a plurality of participants, (ii) monitoring, by an artificial intelligence (AI) agent, the meeting in the virtual reality environment, (iii) detecting, by the AI agent while monitoring the meeting, a trigger behavior by at least one of the participants that correlates to an action within capabilities of the AI agent, and (iv) altering, by the AI agent, the virtual reality environment by performing the action correlated to the trigger behavior. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for virtual assistants in virtual reality meetings.

FIG. 2 is a flow diagram of an exemplary method for virtual assistants performing actions in virtual reality meetings.

FIG. 3 is an illustration of an exemplary virtual reality meeting with a virtual assistant.

FIG. 4 is an illustration of additional exemplary virtual reality meeting with a virtual assistant.

FIG. 5 is an illustration of an additional exemplary virtual reality meeting with a virtual assistant.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

Video and voice conferences are useful tools for collaboration. Adding a third dimension with an augmented reality/virtual reality (AR/VR) conference can improve collaboration further. During such a conference, a user may manually take notes or gather information, which can be time consuming and prone to error. The participant must also context switch between participating in the meeting or experience and note-taking or task searching, negatively impacting the immersive experience by creating an interruption.

The present disclosure is generally directed to systems and methods that enable a participant to interact with and use a generative artificial intelligence (AI) virtual assistant to autogenerate summaries (e.g., meeting summaries, action items, follow-ups, etc.), autogenerate answers to prompts, and/or perform other actions within an AR/VR conference. The use of the generative AI engine may keep the interactions immersive for each participant while optimizing the meeting and experience with real-time data-based summaries, action items, and research. In some examples, the generative AI engine may connect to the interactive input from participants (e.g., audio, video, text, etc.) that allows the models in the generative AI engine to help with the specific needs that arise during the AR/VR meeting.

In some embodiments, the systems described herein may improve the functioning of a computing device by conserving computing resources (e.g., processor usage, network bandwidth, etc.) due to improved AR/VR meeting efficiency that allows for shorter meetings and/or meetings that consume fewer system resources to perform tasks. Additionally, the systems described herein may improve the fields of virtual conferencing and/or generative AI by integrating a generative AI virtual assistant into AR/VR conferences to provide additional features that improve the efficiency and the immersion of the AR/VR conference for participants.

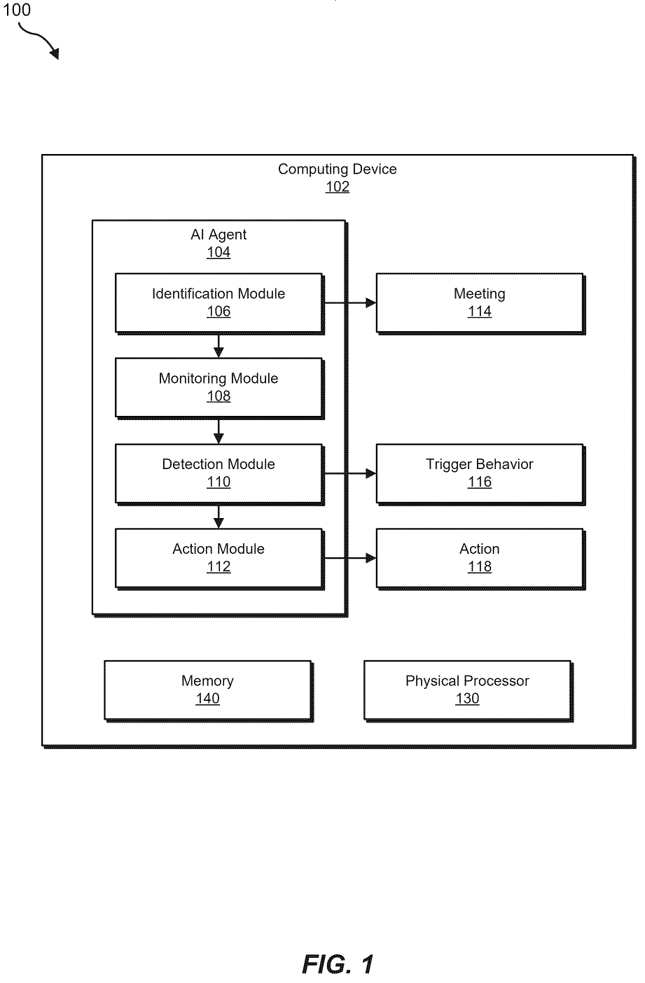

In some embodiments, the systems described herein may perform actions as a virtual assistant in AR/VR meetings via one or more generative AI algorithms. FIG. 1 is a block diagram of an exemplary system 100 for virtual assistants in AR/VR meetings. In one embodiment, and as will be described in greater detail below, a computing device 102 may be configured with an AI agent 104 that comprises a series of modules. For example, AI agent 104 may comprise an identification module 106 that may identify a meeting 114 in a VR environment that includes multiple participants. Additionally, or alternatively, computing device 102 may be configured with identification module 106 independent of AI agent 104 and identification module 106 may initiate AI agent 104. In one embodiment, a monitoring module 108 may monitor meeting 114. In some examples, a detection module 110 may detect a trigger behavior 116 by a participant that correlates to an action 118 within the capabilities of AI agent 104. Next, an action module 112 may alter the VR environment by performing action 118.

Computing device 102 generally represents any type or form of computing device capable of reading computer-executable instructions. For example, computing device 102 may represent an AR/VR device, such as an AR/VR headset or other wearable AR/VR device. Additional examples of computing device 102 may include, without limitation, a laptop, a desktop, a server, a wearable device, a smart device, an artificial reality device, a personal digital assistant (PDA), etc.

AI agent 104 generally represents any one or more generative AI algorithms capable of receiving input, transforming that input, and producing output. In some examples, AI agent 104 may include one or more large language models (LLMs). In some embodiments, AI agent 104 may receive input in the form of text, audio, video, position data of three-dimensional (3D) models, and/or any other relevant type of input.

Meeting 114 may generally represent any interaction between two or more participants in an AR/VR space. For example, meeting 114 may be a professional meeting of colleagues that takes place in a virtual office. In another example, meeting 114 may be a group call of family members in a virtual living room. In one example, meeting 114 may be a virtual class involving a teacher and students in a virtual classroom.

Trigger behavior 116 generally represents any behavior interpreted by the AI agent as a trigger for an action. For example, a participant may directly address the AI agent vocally or via a chat command. In another example, the AI agent may detect a trigger behavior that does not directly reference or address the AI agent. For example, a participant may mention or describe a digital file and the AI agent may interpret this as a trigger behavior for the action of displaying a link to open the digital file. In another example, a participant may move their avatar in the virtual environment and the AI agent may interpret this movement as a trigger to annotate a transcript of the meeting to describe the movement. In various examples, a trigger behavior may include speech, text, movement within a virtual environment, interaction with a user interface, and/or interaction with an object within a virtual environment.

Action 118 generally represents any type of action that can be performed by an AI agent. Examples of action 118 may include, without limitation, creating a transcript, displaying a transcript, annotating a transcript, summarizing a transcript, displaying a 3D model, modifying a 3D model, generating a user interface, displaying a user interface, modifying a user interface, retrieving a file, detecting permissions on a file, and/or any other suitable action.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally, or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

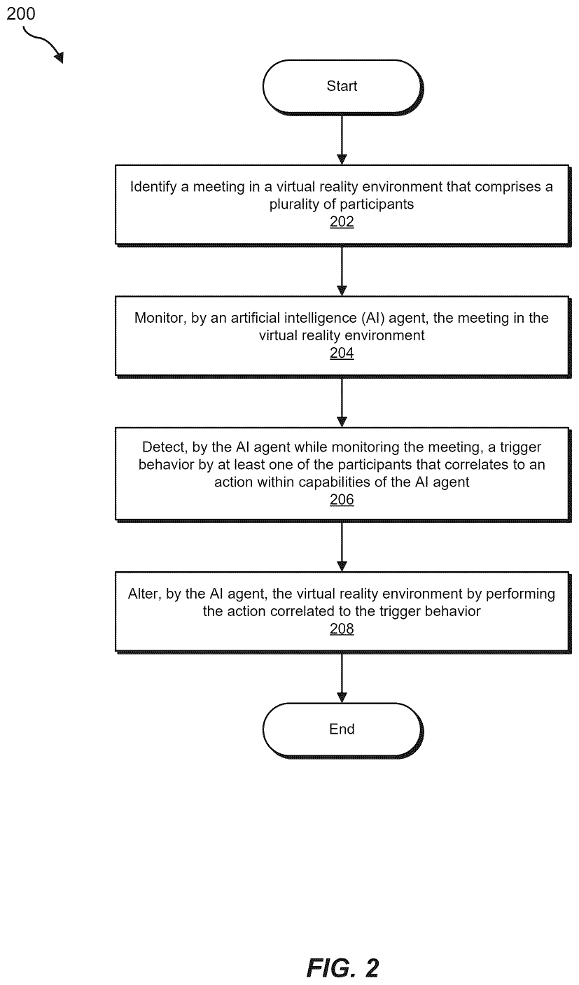

FIG. 2 is a flow diagram of an exemplary method 200. In some examples, at step 202, the systems described herein may identify a meeting in a VR environment that includes a plurality of participants.

The systems described herein may identify a variety of types of meetings. For example, the systems described herein may identify a conference call in a professional environment, a group call of friends or family, a meeting between two users, and/or any other type of meeting within a VR environment. In some embodiments, the systems described herein may initialize the AI agent as soon as the meeting is initialized. Additionally, or alternatively, the systems described herein may initialize the AI agent for the meeting in response to a trigger, such as a request from a participant to initialize the AI agent.

In one embodiment, the AI agent may be represented within the meeting by a 3D model. For example, the AI agent may be represented by a human model or another type of 3D model. In some examples, the systems described herein may enable meeting participants to interact with the AI agent via the 3D model that represents the agent, such as pressing a button on the model to turn monitoring on or off.

In some examples, at step 204, the systems described herein may monitor, by an AI agent, the meeting in the virtual reality environment.

The AI agent may monitor the meeting in a variety of ways. For example, the AI agent may monitor audio of the meeting, such as speech spoken by participants. Additionally, or alternatively, the AI agent may monitor movement of the participants' avatars within the VR environment. In some embodiments, the AI agent may monitor the movement and/or other characteristics of other 3D models within the VR environment that are not the participants' avatars. In some examples, the AI agent may monitor additional features of the VR environment, such as lighting, ambient sound, etc.

In some embodiments, while monitoring the meeting, the AI agent may create a transcript of the meeting. For example, the AI agent may record speech spoken during the meeting to create a transcript.

In some examples, at step 206, the systems described herein may detect, by the AI agent while monitoring the meeting, a trigger behavior by at least one of the participants that correlates to an action within capabilities of the AI agent. In some examples, at step 208, the systems described herein may alter, by the AI agent, the virtual reality environment by performing the action correlated to the trigger behavior.

The systems described herein may detect a variety of different trigger behaviors and perform a variety of different correlated actions. In some examples, the AI agent may be triggered by participant speech, by participant movement, and/or by other actions of participants or elements of the VR environment. In some examples, the AI agent may monitor for a direct reference to the AI agent by a participant. Additionally, or alternatively, the AI agent may detect trigger behaviors that are not a reference to the AI agent by a participant.

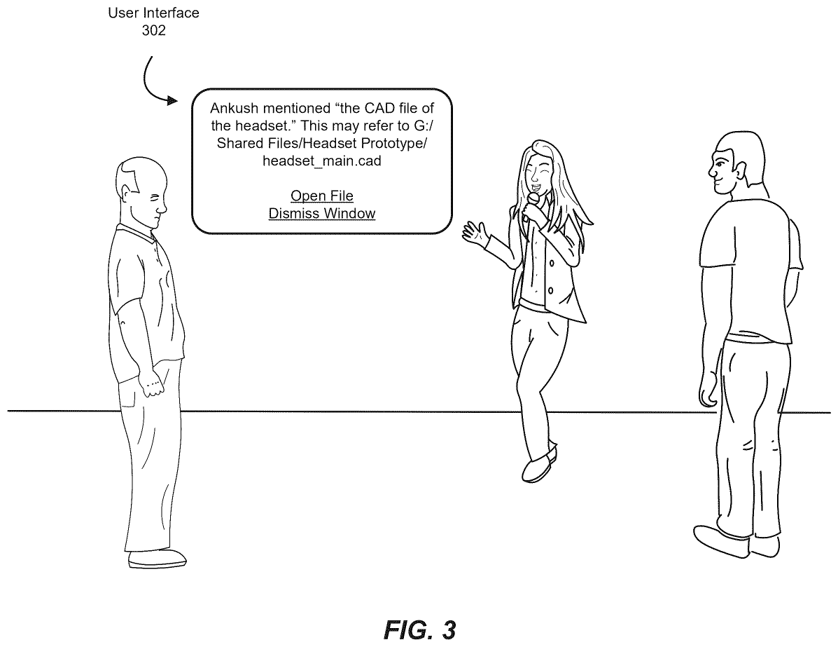

For example, the AI agent may detect a trigger behavior that includes a reference to a digital file. In one example, as illustrated in FIG. 3, several co-workers may be having a meeting in a VR environment. In one example, a participant may verbally mention a CAD file of a headset. The AI agent may detect this verbal reference to a file and generate a user interface 302 with a link to open the file. In some embodiments, the AI agent may locate the file based at least in part on a job type of the participant. For example, if the participant who referenced the file is an engineer, the AI agent may search for the file in a repository of engineering files, while if the participant who referenced the file is a lawyer, the AI agent may search for the file in a repository of legal files. In some embodiments, the AI agent may use additional context clues to identify and/or locate the file, such as 3D models loaded into the VR environment, the current topic of conversation, the topic of the meeting, recent files opened by participants, etc.

In some embodiments, the AI may evaluate the permissions of each participant in the meeting and only display the user interface with the link to the file to participants who have permission to view the file. Additionally, or alternatively, the AI agent may display a prompt to the user who mentioned the file asking whether to extend permissions (e.g., temporary permissions or permanent permissions) to other participants in the meeting to view the file. In some embodiments, the systems described herein may enable a user to set permissions on a per-file and/or per-folder basis as to whether an AI agent should display a link to the file during VR meetings. In some examples, all participants may have permission to view the file and the AI agent may display user interface 302 to all participants. The systems described herein may generate a user interface in various form factors, such as a floating window, a window docked to another object, a shape, an annotation in a transcript, an addition to a list of links to files previously mentioned, and/or any other suitable type of user interface.

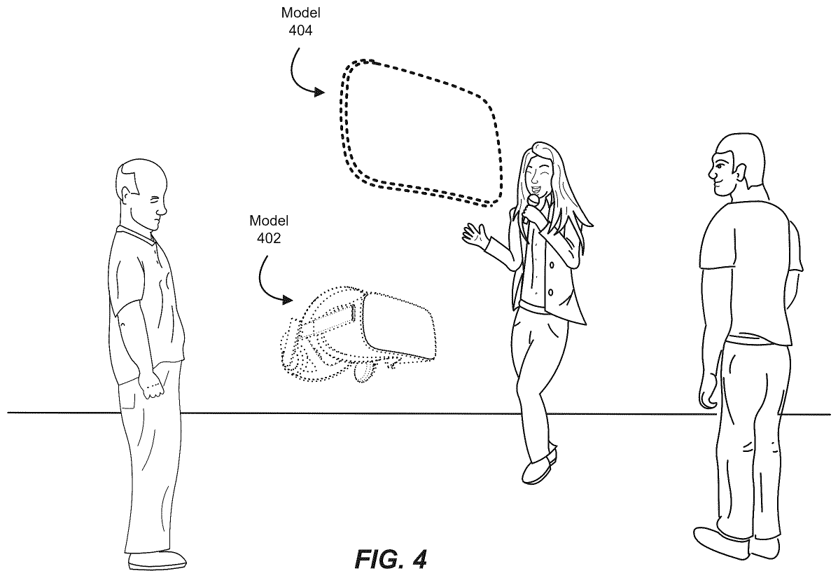

In some examples, the AI agent may generate, move, and/or modify a 3D model in the VR environment in response to a trigger behavior. For example, a user in a meeting in a VR environment may gesture at, touch, and/or verbally refer to a 3D model and the systems described herein may identify this action as a trigger behavior. In one example, as illustrated in FIG. 4, a user may gesture to the front surface of a model 402 of a headset. In response, the AI agent may generate a larger version of the front surface of the headset, model 404, for examination by participants in the meeting. In another example, a user may refer to a component hidden within the headset, such as a battery, and the AI agent may modify the headset model to be transparent so that the battery becomes visible. In one example, a user may refer to a related component that is not being displayed as a model, such as a hand-held controller for the headset, and the AI agent may generate and display a 3D model of the hand-held controller. In one example, a user may make a shooing gesture at model 402 and, in response, the AI agent may remove model 402 from the VR environment.

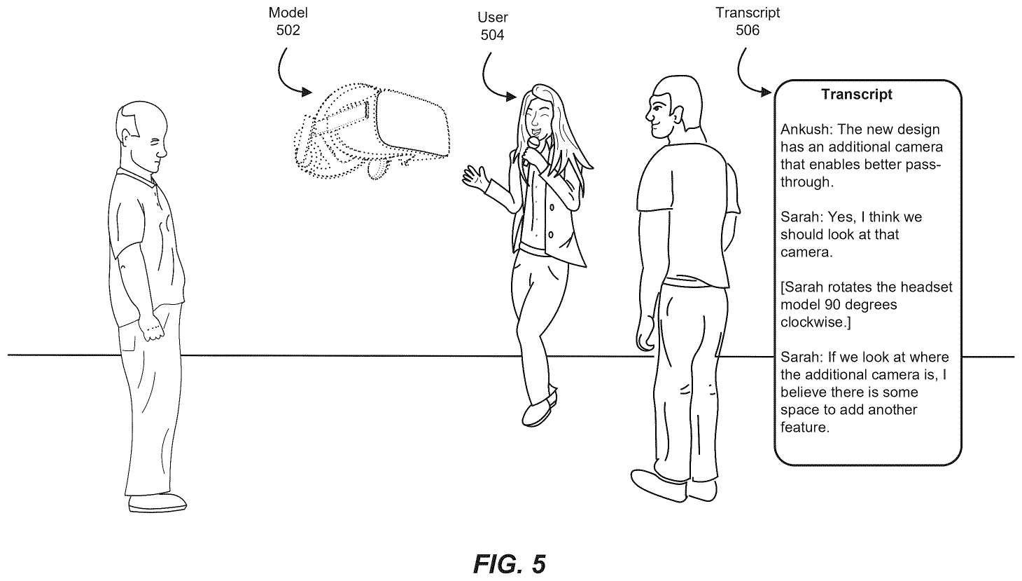

In some examples, the AI agent may annotate, summarize, display, and/or otherwise modify a transcript of the meeting in response to a trigger behavior. In on example, the AI agent may annotate a transcript with descriptions of a user's and/or a model's movement in the VR environment. For example, as illustrated in FIG. 5, a user 504 may rotate a model 502. In response to this trigger behavior, an AI agent may annotate a transcript 506 of the meeting to describe user 504 rotating model 502. Similarly, the AI agent may annotate transcript 506 to describe actions and/or movements of users, add links to referenced files or other resources, and/or describe changes to models and/or the VR environment. In some examples, the AI agent may add additional details to the transcript. For example, if a user teaching a cooking class adds shrimp to a pan while saying, “I am adding the next ingredient,” the AI agent may identify the 3D model as being shrimp and may annotate the transcript to state that the teacher is adding shrimp to the pan.

In some examples, the AI agent may generate a summary of all or a portion of the transcript. In one example, the AI agent may generate the summary based in part on a job type category of a user requesting the summary. For example, an AI agent may summarize a transcript using technical engineering terms if the summary is requested by an engineer but may use layman's terms to describe engineering concepts if the summary is requested by a non-engineer. In another example, if the summary is requested by a lawyer, the AI agent may focus the summary on any legal issues discussed in the meeting while if the summary is requested by an engineer, the AI agent may focus the summary on engineering issues discussed in the meeting.

In some embodiments, the AI agent may generate a list of action items that resulted from the meeting. For example, the AI agent may generate and display a list of next steps to take to move forward a project discussed in the meeting. In one embodiment, the AI agent may interface with other systems to facilitate performing action items. For example, if the topic of the meeting is an invention brainstorming session, the AI agent may fill out an invention disclosure template based on content from the meeting and may prompt a user to submit the invention disclosure template to a disclosure tracking system.

As described above, the systems and methods described herein may improve the immersion, efficiency, and/or enjoyableness of AR/VR meetings by monitoring the meeting for a trigger behavior and then automatically performing an action that correlates to that trigger behavior, performing tasks such as linking files, generating or modifying 3D models, and creating or summarizing transcripts without requiring direct user intervention.

Embodiments of the present disclosure may include or be implemented in conjunction with various types of artificial reality, virtual reality, and/or augmented reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

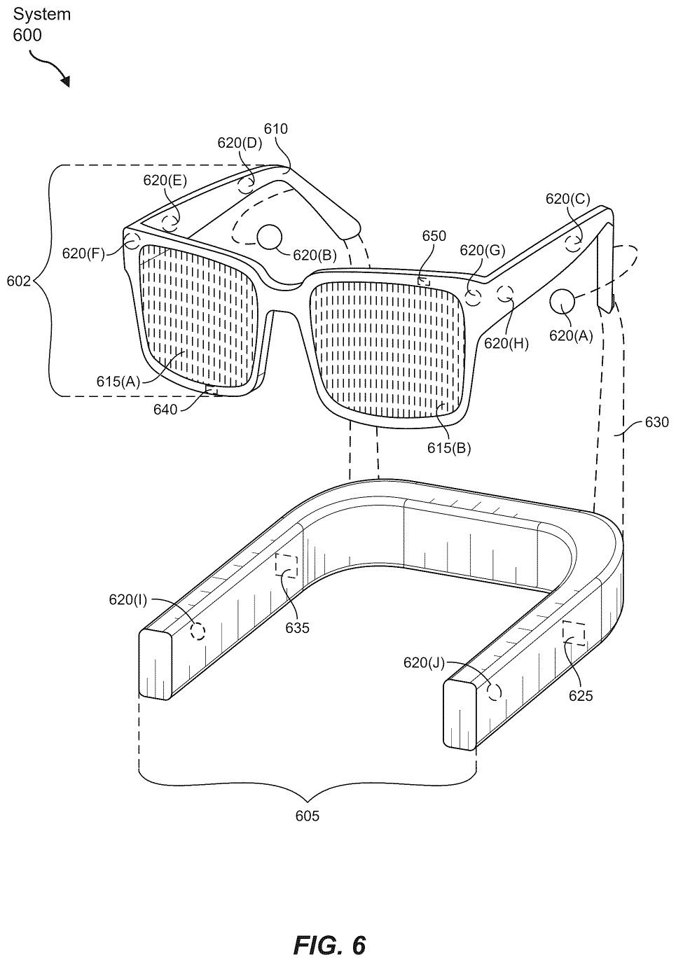

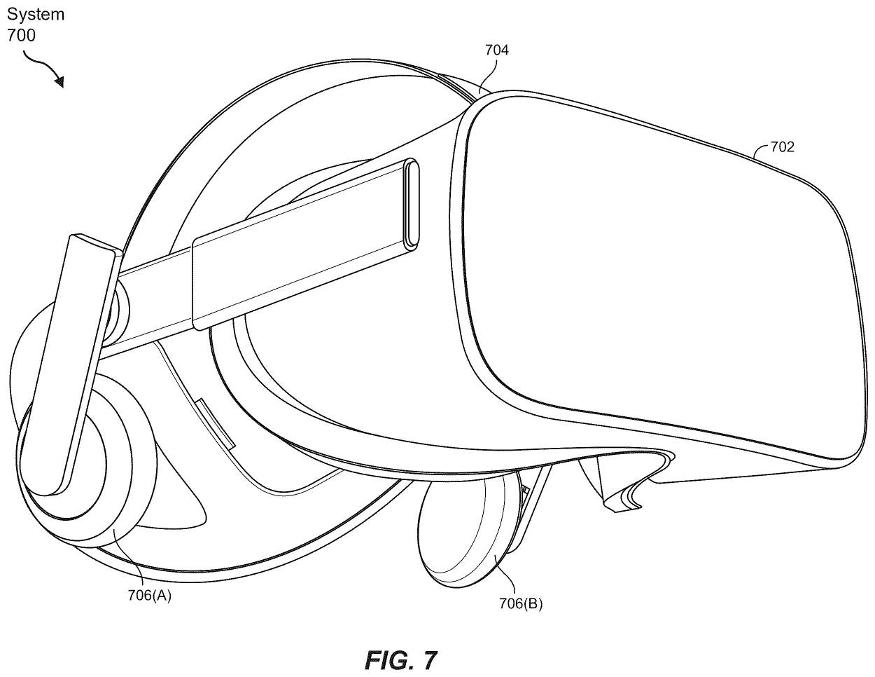

Artificial-reality systems may be implemented in a variety of different form factors and configurations. Some artificial reality systems may be designed to work without near-eye displays (NEDs). Other artificial reality systems may include an NED that also provides visibility into the real world (such as, e.g., augmented-reality system 600 in FIG. 6) or that visually immerses a user in an artificial reality (such as, e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

In some examples, augmented-reality system 600 may also include a microphone array with a plurality of acoustic transducers 620(A)-120(J), referred to collectively as acoustic transducers 620. Acoustic transducers 620 may represent transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(I) and 620 (J), which may be positioned on a corresponding neckband 605.

In some embodiments, one or more of acoustic transducers 620(A)-(J) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality system 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a BLUETOOTH connection). In still other embodiments, acoustic transducers 620(A) and 620(B) may not be used at all in conjunction with augmented-reality system 600.

Acoustic transducers 620 on frame 610 may be positioned in a variety of different ways, including along the length of the temples, across the bridge, above or below display devices 615(A) and 615(B), or some combination thereof. Acoustic transducers 620 may also be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620 (l) and 620(J)) that are part of the microphone array (or potentially form their own microphone subarray). Neckband 605 may also include a controller 625 and a power source 635.

Acoustic transducers 620 (l) and 620(J) of neckband 605 may be configured to detect sound and convert the detected sound into an electronic format (analog or digital). In the embodiment of FIG. 6, acoustic transducers 620 (l) and 620(J) may be positioned on neckband 605, thereby increasing the distance between the neckband acoustic transducers 620 (l) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium-ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUs), one or more tracking emitters or detectors, and/or any other suitable device or system for creating an artificial-reality experience.

Artificial reality systems may include a variety of types of visual feedback mechanisms. For example, display devices in augmented-reality system 600 and/or virtual-reality system 700 may include one or more liquid crystal displays (LCDs), light emitting diode (LED) displays, microLED displays, organic LED (OLED) displays, digital light project (DLP) micro-displays, liquid crystal on silicon (LCOS) micro-displays, and/or any other suitable type of display screen. These artificial reality systems may include a single display screen for both eyes or may provide a display screen for each eye, which may allow for additional flexibility for varifocal adjustments or for correcting a user's refractive error. Some of these artificial reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial reality experience in one or more of these contexts and environments and/or in other contexts and environments.

### EXAMPLE EMBODIMENTS

Example 1: A method for virtual assistants performing actions during virtual reality meetings may include (i) identifying a meeting in a virtual reality environment that includes a plurality of participants, (ii) monitoring, by an artificial intelligence (AI) agent, the meeting in the virtual reality environment, (iii) detecting, by the AI agent while monitoring the meeting, a trigger behavior by at least one of the participants that correlates to an action within capabilities of the AI agent, and (iv) altering, by the AI agent, the virtual reality environment by performing the action correlated to the trigger behavior.

Example 2: The computer-implemented method of example 1, where the trigger behavior includes speech.

Example 3: The computer-implemented method of examples 1-2, where the trigger behavior includes physical movement within the virtual reality environment.

Example 4: The computer-implemented method of examples 1-3, where the trigger behavior includes a reference to a digital file and the action includes displaying a user interface within the virtual reality environment to one or more of the participants that includes an option to open the digital file.

Example 5: The computer-implemented method of examples 1-4, where displaying the user interface within the virtual environment includes identifying a subset of the participants with permissions to view the digital file, displaying the user interface to the subset of the participants with the permissions, and avoiding displaying the user interface to the participants not in the subset.

Example 6: The computer-implemented method of examples 1-5, where the action includes generating a three-dimensional model within the virtual environment.

Example 7: The computer-implemented method of examples 1-6, where the action includes modifying a three-dimensional model within the virtual environment.

Example 8: The computer-implemented method of examples 1-7, where monitoring the meeting includes creating a transcript of the meeting and the action includes creating and displaying a summary of at least a portion of the transcript of the meeting.

Example 9: The computer-implemented method of examples 1-8, where creating the summary includes identifying a job category of a participant in the meeting and tailoring the summary to the job category of the participant.

Example 10: The computer-implemented method of examples 1-9, where creating the summary includes detecting a physical action performed a participant within the virtual environment and annotating the transcript of the meeting with a description of the physical action.

Example 11: The computer-implemented method of examples 1-10 may further include displaying a three-dimensional model that represents the AI agent within the virtual reality environment.

Example 12: A system for virtual assistants for virtual reality meetings may include at least one physical processor and physical memory including computer-executable instructions that, when executed by the physical processor, cause the physical processor to (i) identify a meeting in a virtual reality environment that includes a plurality of participants, (ii) monitor, by an AI agent, the meeting in the virtual reality environment, (iii) detect, by the AI agent while monitoring the meeting, a trigger behavior by at least one of the participants that correlates to an action within capabilities of the AI agent, and (iv) alter, by the AI agent, the virtual reality environment by performing the action correlated to the trigger behavior.

Example 13: The system of example 12, where the trigger behavior includes speech.

Example 12: The system of examples 12-13, where the trigger behavior includes physical movement within the virtual reality environment.

Example 15: The system of examples 12-14, where the trigger behavior includes a reference to a digital file and the action includes displaying a user interface within the virtual reality environment to one or more of the participants that includes an option to open the digital file.

Example 16: The system of examples 12-15, where displaying the user interface within the virtual environment includes identifying a subset of the participants with permissions to view the digital file, displaying the user interface to the subset of the participants with the permissions, and avoiding displaying the user interface to the participants not in the subset.

Example 17: The system of examples 12-16, where the action includes generating a three-dimensional model within the virtual environment.

Example 18: The system of examples 12-17, where the action includes modifying a three-dimensional model within the virtual environment.

Example 19: The system of examples 12-18, where monitoring the meeting includes creating a transcript of the meeting and the action includes creating and displaying a summary of at least a portion of the transcript of the meeting.

Example 20: A non-transitory computer-readable medium may include one or more computer-readable instructions that, when executed by at least one processor of a computing device, cause the computing device to (i) identify a meeting in a virtual reality environment that includes a plurality of participants, (ii) monitor, by an AI agent, the meeting in the virtual reality environment, (iii) detect, by the AI agent while monitoring the meeting, a trigger behavior by at least one of the participants that correlates to an action within capabilities of the AI agent, and (iv) alter, by the AI agent, the virtual reality environment by performing the action correlated to the trigger behavior.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive AR/VR meeting data to be transformed, transform the AR/VR meeting data to detect a trigger behavior, output a result of the transformation to perform a function in the AR/VR environment, use the result of the transformation to alter the AR/VR environment, and store the result of the transformation to maintain a transcript and/or log. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying a meeting in a virtual reality environment that comprises a plurality of participants;
monitoring, by an artificial intelligence (AI) agent, the meeting in the virtual reality environment;
detecting, by the AI agent while monitoring the meeting, a trigger behavior by at least one of the participants that correlates to an action within capabilities of the AI agent; and
altering, by the AI agent, the virtual reality environment by performing the action correlated to the trigger behavior.

2. The computer-implemented method of claim 1, wherein the trigger behavior comprises speech.

3. The computer-implemented method of claim 1, wherein the trigger behavior comprises physical movement within the virtual reality environment.

4. The computer-implemented method of claim 1, wherein:
the trigger behavior comprises a reference to a digital file; and
the action comprises displaying a user interface within the virtual reality environment to one or more of the participants that comprises an option to open the digital file.

5. The computer-implemented method of claim 4, wherein displaying the user interface within the virtual environment comprises:
identifying a subset of the participants with permissions to view the digital file;
displaying the user interface to the subset of the participants with the permissions; and
avoiding displaying the user interface to the participants not in the subset.

6. The computer-implemented method of claim 1, wherein the action comprises generating a three-dimensional model within the virtual environment.

7. The computer-implemented method of claim 1, wherein the action comprises modifying a three-dimensional model within the virtual environment.

8. The computer-implemented method of claim 1, wherein:
monitoring the meeting comprises creating a transcript of the meeting; and
the action comprises creating and displaying a summary of at least a portion of the transcript of the meeting.

9. The computer-implemented method of claim 8, wherein creating the summary comprises:
identifying a job category of a participant in the meeting; and
tailoring the summary to the job category of the participant.

10. The computer-implemented method of claim 8, wherein creating the summary comprises:
detecting a physical action performed a participant within the virtual environment; and
annotating the transcript of the meeting with a description of the physical action.

11. The computer-implemented method of claim 1, further comprising displaying a three-dimensional model that represents the AI agent within the virtual reality environment.

12. A system comprising:
at least one physical processor;
physical memory comprising computer-executable instructions that, when executed by the physical processor, cause the physical processor to:
identify a meeting in a virtual reality environment that comprises a plurality of participants;
monitor, by an AI agent, the meeting in the virtual reality environment;
detect, by the AI agent while monitoring the meeting, a trigger behavior by at least one of the participants that correlates to an action within capabilities of the AI agent; and
alter, by the AI agent, the virtual reality environment by performing the action correlated to the trigger behavior.

13. The system of claim 12, wherein the trigger behavior comprises speech.

14. The system of claim 12, wherein the trigger behavior comprises physical movement within the virtual reality environment.

15. The system of claim 12, wherein:
the trigger behavior comprises a reference to a digital file; and
the action comprises displaying a user interface within the virtual reality environment to one or more of the participants that comprises an option to open the digital file.

16. The system of claim 15, wherein displaying the user interface within the virtual environment comprises:
identifying a subset of the participants with permissions to view the digital file;
displaying the user interface to the subset of the participants with the permissions; and
avoiding displaying the user interface to the participants not in the subset.

17. The system of claim 12, wherein the action comprises generating a three-dimensional model within the virtual environment.

18. The system of claim 12, wherein the action comprises modifying a three-dimensional model within the virtual environment.

19. The system of claim 12, wherein:
monitoring the meeting comprises creating a transcript of the meeting; and
the action comprises creating and displaying a summary of at least a portion of the transcript of the meeting.

20. A non-transitory computer-readable medium comprising one or more computer-readable instructions that, when executed by at least one processor of a computing device, cause the computing device to:
identify a meeting in a virtual reality environment that comprises a plurality of participants;
monitor, by an AI agent, the meeting in the virtual reality environment;
detect, by the AI agent while monitoring the meeting, a trigger behavior by at least one of the participants that correlates to an action within capabilities of the AI agent; and
alter, by the AI agent, the virtual reality environment by performing the action correlated to the trigger behavior.
